(19) United States
(12) Patent Application Publication
(10) Pub. No.: US 2018/0189449 A1
(43) Pub. Date: Jul. 5, 2018

(54) TRACKING ITEMS USED FOR PROVIDING MEDICAL SERVICES

(71) Applicant: International Business Machines Corporation, Armonk, NY (US)

(72) Inventors: Samuel M. Karumba, Nairobi (KE); Clifford A. Pickover, Yorktown Heights, NY (US); Komminist Weldemariam, Nairobi (KE)

(21) Appl. No.: 15/398,272

(22) Filed: Jan. 4, 2017

(51) Int. Cl. G06F 19/00; H04L 9/06

(52) U.S. Cl. CPC G06F 19/327; G06F 19/3431; H04L 9/0637

(57) ABSTRACT

A secure chain of data blocks is maintained at a given computing node, wherein the given computing node is part of a set of computing nodes in a distributed network of computing nodes, and wherein each of the set of computing nodes maintains the secure chain of data blocks. The secure chain of data blocks maintained at each computing node comprises one or more data blocks that respectively represent one or more transactions associated with a physical item used for providing a medical service. At least one data block is added to the secure chain of data blocks maintained at the given computing node as a function of a triggering event relevant to the physical item used for providing a medical service. The triggering event is a function of at least one risk assessment value relevant to the physical item.

### BACKGROUND

Managing items used for providing medical services, for example, physical items such as instruments and tools used for surgical procedures, has received increased consideration in recent years. For example, tracking of medical instruments in hospitals, doctors' offices and other health service environments is generally considered important since it is seen as a way to improve patient safety. This is because the use of medical instruments with a first patient, followed by reuse with a second patient, has the potential to result in disease transmission from the first patient to the second patient (e.g., assuming the first patient has a transmissible disease) if such instruments are not properly sterilized between procedures.

While this risk has existed for centuries, reasons for increased consideration for proper management of medical instruments in recent years vary but include factors such as advances in technology used to identify physical items, as well as the spread of otherwise regional infectious diseases to other regions of the globe due to the increase in global travel.

Thus, more medical facilities are seeing instrument tracking as a necessity as they look to improve patient safety, as well as address secondary issues such as cost and instrument inventory management. However, effectively tracking physical items presents unique challenges particularly in health service environments.

### SUMMARY

Embodiments provide techniques for tacking physical items used for providing medical services.

In one embodiment, a method comprises the following steps. A secure chain of data blocks is maintained at a given computing node, wherein the given computing node is part of a set of computing nodes in a distributed network of computing nodes, and wherein each of the set of computing nodes maintains the secure chain of data blocks. The secure chain of data blocks maintained at each computing node comprises one or more data blocks that respectively represent one or more transactions associated with a physical item used for providing a medical service. At least one data block is added to the secure chain of data blocks maintained at the given computing node as a function of a triggering event relevant to the physical item used for providing a medical service. The triggering event is a function of at least one risk assessment value relevant to the physical item.

In another embodiment, an apparatus comprises at least one processor and a memory operatively coupled to the processor to form a given computing device that is part of a set of computing nodes in a distributed network of computing nodes, wherein each of the set of computing nodes maintains a secure chain of data blocks. The processor and memory are configured to: maintain the secure chain of data blocks at the given computing node, wherein the secure chain of data blocks maintained at each computing node comprises one or more data blocks that respectively represent one or more transactions associated with a physical item used for providing a medical service; and add at least one data block to the secure chain of data blocks maintained at the given computing node as a function of a triggering event relevant to the physical item used for providing a medical service. The triggering event is a function of at least one risk assessment value relevant to the physical item.

In yet another embodiment, a computer program product comprises a processor-readable storage medium having encoded therein executable code of one or more software programs. The one or more software programs when executed by the one or more processors implement steps of: maintaining a secure chain of data blocks at a given computing node, wherein the given computing node is part of a set of computing nodes in a distributed network of computing nodes wherein each of the set of computing nodes maintains the secure chain of data blocks, wherein the secure chain of data blocks maintained at each computing node comprises one or more data blocks that respectively represent one or more transactions associated with a physical item used for providing a medical service; and adding at least one data block to the secure chain of data blocks maintained at the given computing node as a function of a triggering event relevant to the physical item used for providing a medical service. The triggering event is a function of at least one risk assessment value relevant to the physical item.

Advantageously, illustrative embodiments provide effective techniques for tracking items such as surgical instruments and tools (surgical items) in a health care environment by creating a secure (e.g., validated and protected) chain of data blocks representing transactions associated with the surgical items (e.g., registration, use, sterilization, disposal, risk assessment, etc.). In this manner, health care facilities, professionals, and patients themselves, have increased assurances that the various items that are being used in furtherance of health care are the correct items being used in the correct way with the correct precautions being taken into consideration.

These and other exemplary embodiments of the invention will be described in or become apparent from the following detailed description of exemplary embodiments, which is to be read in connection with the accompanying drawings.

### BRIEF DESCRIPTION OF THE DRAWINGS

FIG. 1 illustrates a blockchain computational system with which one or more embodiments of the invention are implemented.

FIG. 2 illustrates a computing platform for tracking surgical items according to an embodiment of the invention.

FIG. 3A illustrates a surgical item lifecycle and data sets associated therewith according to an embodiment of the invention.

FIG. 3B illustrates a risk assessment data set with risk factors according to an embodiment of the invention.

FIG. 4A illustrates a malaria prevalence map for use with a computing platform for tracking surgical items according to an embodiment of the invention.

FIG. 4B illustrates a cholera outbreak map for use with a computing platform for tracking surgical items according to an embodiment of the invention.

FIG. 5 illustrates a blockchain for a surgical item according to an embodiment of the invention.

FIG. 6A illustrates a blockchain methodology for tracking a surgical item according to an embodiment of the invention.

FIG. 6B illustrates a methodology for adding data to a blockchain that is used to track a surgical item according to an embodiment of the invention.

FIG. 7 depicts a computer system in accordance with which one or more components/steps of techniques of the invention may be implemented according to an embodiment of the invention.

FIG. 8 depicts a cloud computing environment according to an embodiment of the invention.

FIG. 9 depicts abstraction model layers according to an embodiment of the present invention.

### DETAILED DESCRIPTION

Illustrative embodiments will be described below for tracking (more generally, managing) physical items used for providing medical services. While illustrative techniques described herein are particularly well-suited for tracking physical items such as surgical instruments and tools (surgical items), it is to be understood that embodiments are not intended to be limited to such instruments and tools. Also, the term “physical item” is intended to distinguish from items that are not physical in nature, e.g., a tangible, handheld instrument used in the operating room by a surgeon as opposed to a software-based medical record. Furthermore, while a “blockchain” technology will be described in one or more illustrative implementations, other types of data management technologies that generate a secure chain of data blocks maintained at computing nodes in a distributed network may be employed in one or more embodiments.

Prior to explaining the techniques for tracking physical items used for providing medical services, a brief explanation of the blockchain technology will now be given.

Blockchain is the name given to a technology that enables creation of a digital ledger or record of transactions and sharing of this ledger or record among a distributed network of computers. Blockchain was originally developed as part of the bitcoin technology. Bitcoin is a digital asset and payment system. Blockchain technology uses cryptography to allow each participant on the network to manipulate the ledger in a secure way without the need for a central point of control. In the context of bitcoin, the blockchain technology maintains a public ledger of all bitcoin transactions that have previously occurred (i.e., a chain of transactions). In the bitcoin case, every compatible client is able to connect to the network, send new transactions to the network, verify transactions, and take part in the competition (called mining) to create new blocks. However, it is realized herein that blockchain technology can be adapted for other transactional applications to establish trust, accountability and transparency without requiring a central authority.

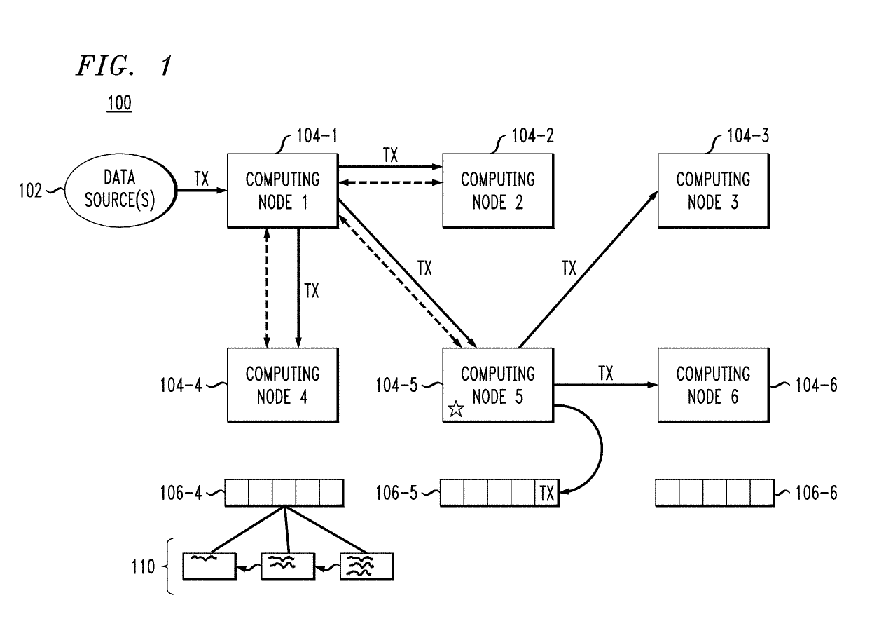

FIG. 1 illustrates a blockchain computational system 100 with which one or more embodiments of the invention may be implemented. As shown, the system 100 comprises one or more data sources 102 operatively coupled to at least one of a plurality of distributed peer computing nodes 104-1, 104-2, . . . , 104-6. The system 100 may have more or less computing nodes than the number illustrated in FIG. 1. Each computing node in the system 100 is configured to maintain a blockchain which is a cryptographically secured (via a cryptographic hash function) record or ledger of data blocks that represent respective transactions within some environment. A cryptographic hash function is a cryptographic function which takes an input (or “message”) and returns a fixed-size alphanumeric string, which is called the hash value (sometimes called a message digest, a digital fingerprint, a digest, or a checksum).

In FIG. 1, computing nodes 104-4, 104-5, and 104-6 are shown each maintaining the same blockchain (respectively illustrated as blockchains 106-4, 106-5, and 106-6). Although not expressly shown, each computing node in the system 100 is configured to be able to maintain this same blockchain. Each blockchain is a growing list of data records hardened against tampering and revision (i.e., secure). Each block in the blockchain (illustratively referenced as block 108 in blockchain 106-4) holds batches of one or more individual transactions and the results of any blockchain executables (e.g., computations that can be applied to the transactions). Each block typically contains a timestamp and information linking it to a previous block. More particularly, each subsequent block in the blockchain (e.g., 106-4, 106-5, 106-6, etc.) is a data block that includes a given transaction and a hash value of the previous block in the chain (i.e., the previous transaction). Thus, each data block in the blockchain represents a given set of transaction data plus a set of all previous transaction data (e.g., as illustratively depicted as 110 in FIG. 1).

Assume a new set of transaction data (new transaction TX) is obtained from one of the one or more data sources 102, and received by computing node 1 (104-1). Computing node 1 (104-1) can provide the new transaction TX to all or a subset of computing nodes in the system 100. In this case, TX is sent to computing node 2 (104-2), computing node 4 (104-4), and computing node 5 (104-5).

Note that computing node 104-5 is marked with a star symbol to denote it as a leader in a consensus protocol. That is, the computing nodes in the system 100 each are configured to participate in a consensus protocol as peers with one peer being designated as a leader. Any peer can assume the role of leader for a given iteration of the consensus protocol. In general, the leader receives all transactions from the participating peers in the system and creates a new block for the new transaction. The new block is sent out by the leader node to one or more of the other peer computing nodes (e.g., 104-3 and 104-6 as illustrated in FIG. 1) which double check (validate) that the leader computed the new block properly (i.e., the validating nodes agree by consensus). If consensus is reached, then the computing nodes in the system 100 add the new block to the blockchain they currently maintain. As a result, after the new transaction TX is processed by the system 100, each computing node should now have a copy of the same updated blockchain stored in its memory. Then, when a new transaction comes into the system 100, the above-described process of adding the transaction to the blockchain is repeated.

It is to be understood that any single computing node may itself serve as the receiver, validator, and block generator for of new transaction data set. However, in the context of a consensus protocol, the more nodes that validate the given transaction, the more trustworthy the data block is considered.

It is to be further understood that the above description represents one illustrative blockchain computation process and that embodiments of the invention are not limited to the above or any particular blockchain computation implementation. As such, other appropriate cryptographic processes may be used to maintain and add to a secure chain of data blocks in accordance with embodiments of the invention.

Illustrative embodiments adapt the blockchain computational system 100 of FIG. 1 to manage physical items used for providing medical services. More particularly, as will be described in detail herein, non-limiting, illustrative embodiments apply blockchain technology to a hospital environment with a focus on surgical items (e.g., instruments, tools and other surgical inventory items). Such illustrative embodiments use blockchain tracking of surgical items, as they are stored, brought into the operating room, used within the cavity of a patient, removed, sterilized, reused again, etc. Management of these physical items is useful for tracking provenance, finding items errantly left in patients, and/or tracking disease if improper sterilization is applied. One or more of these steps in the lifecycle (i.e., temporal life span) of the surgical item may be considered as a “transaction.” The blockchain technology is then used to securely maintain data about such transactions (i.e., transaction data) to establish trust, accountability and transparency with regard to the surgical items without requiring a central authority. Such techniques have wide ranging advantages for medical facilities that are geographically distributed.

In order to manage the surgical item, the item itself first has to be uniquely identified. To provide identification for tracking, in some embodiments, the surgical item is passed in front of an imager with deep neural networks to identify it. In other embodiments, items may have identification (ID) codes (e.g., on the tool in various manners) which can be read, barcodes, imprinted alpha numeric characters, two-dimensional data matrix, fluorescent paint identification, InfoDot® technology (Secure Innovations Inc.), etc. In still other embodiments, radio frequency identification (RFID) tags may be employed. Other techniques may be used to identify the surgical items. Identification techniques are also employed with the surgical item so that the item can be identified even if it is within a container (e.g., sealed sterilization case) or errantly left in the body of a surgical patient.

Furthermore, as will be explained in detail herein, illustrative embodiments provide a blockchain computational system for implementing the above and other management features wherein each computing node comprises controller modules for managing transaction data, blockchain computation, and risk assessment. More particularly, each computing node in the system is configured to track and detect the use of surgical items, detect or determine risk to a patient based on the tracking and detection and advanced analytics, and based on the risk, the computing node (and/or one or more other nodes in the system) sends alerts or notifies health care personnel (e.g., physicians and other healthcare professionals) so they can take appropriate actions.

As such, surgical item transactions associated with a given stakeholder (someone or something that is associated with the given environment) are compiled into a chain of surgical inventory transaction blocks. The chain can be considered a chronicle of a surgical item's path through time. When a transaction is conducted (e.g., a surgical tool is used or accessed), the corresponding tool parameters are sent to one or more of the computing nodes in the system for validation. The one or more computing nodes establish a validity of the transaction and generate a new block. Once the new block has been calculated, it can be appended to the stakeholder's inventory blockchain. Various aspects associated with the tool may be tracked such as, but not limited to: user, location, usage, and maintenance of the surgical tool. The system also tracks a possible risk assessment data set which, in one embodiment, is in the form of a multidimensional vector with several dimensions of risk (e.g. procedure performed on someone with communicable diseases, etc.). The system also tracks the method used in sterilization of the tool.

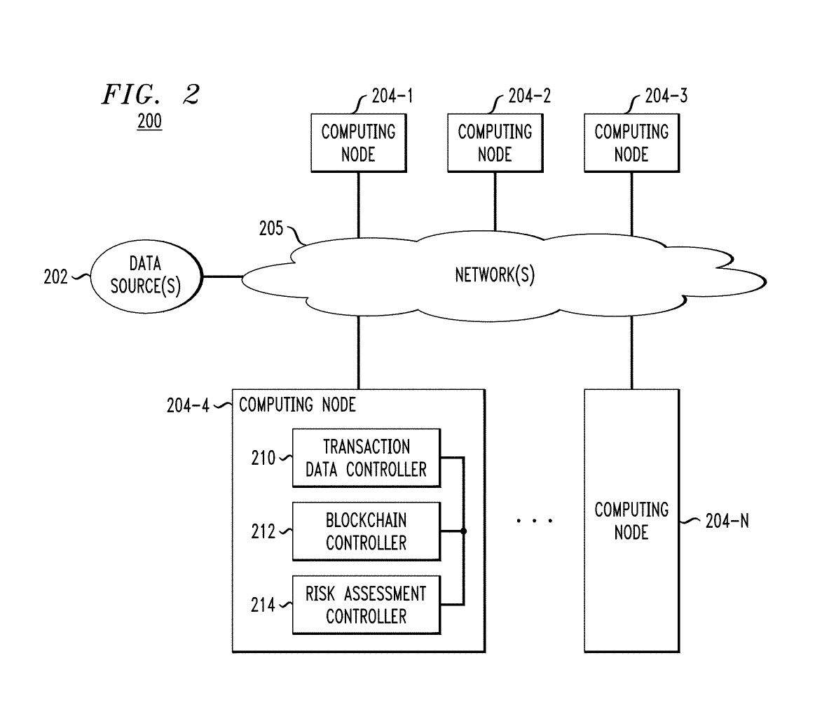

FIG. 2 illustrates a distributed computing platform on which a blockchain computational system (such as system 100 in FIG. 1) can be implemented. More particularly, as shown, the distributed computing platform 200 in FIG. 2 is similar to system 100 in FIG. 1 in that one or more data sources 202 are operatively coupled to a plurality of computing nodes 204-1, 204-2, 204-3, 204-4, . . . , 204-N. In FIG. 2, one or more communication networks 205 are shown as the mechanism for coupling the data sources 202 and the computing nodes 204-1, 204-2, 204-3, 204-4, . . . , 204-N.

As further shown, FIG. 2 illustrates component details of each of the computing nodes. While the component details are representatively depicted for computing node 204-4, each computing node has such components. Each computing node is configured to include a transaction data controller 210, a blockchain controller 212, and a risk assessment controller 214. While functions of each controller will be described in greater detail below, in general: the transaction data controller 210 manages transaction data including, but not limited to, receiving or otherwise obtaining transaction data (item identification data, item use data, etc.); the blockchain controller 212 manages blockchain computation including, but not limited to, accessing the transaction data and generating and validating a block and adding the block to a blockchain; and the risk assessment controller 214 manages risk assessment including, but not limited to, risk factor analysis and alert generation.

While embodiments of the invention are not limited to management of any particular physical item used for providing a medical service, some examples of items that may be tracked through their lifecycle may include: graspers (e.g., such as forceps); clamps and occluders for blood vessels and other organs; retractors (e.g., used to spread open skin, ribs and other tissue); distractors, positioners and stereotactic devices; mechanical cutters (e.g., scalpels, lancets, drill bits, rasps, trocars, ligasure, harmonic scalpel, surgical scissors, rongeurs, etc.); dilators and specula (e.g., for access to narrow passages or incisions); suction tips and tubes (e.g., for removal of bodily fluids); sealing devices (e.g., such as surgical staplers); irrigation and injection needles, tips and tubes (e.g., for introducing fluid); powered devices (e.g., such as drills, dermatomes); scopes and probes (e.g., including fiber optic endoscopes and tactile probes); carriers and appliers for optical, electronic and mechanical devices; ultrasound tissue disruptors, cryotomes and cutting laser guides; and measurement devices (e.g., such as rulers and calipers). These items are also known as “anchor items” for the blockchain computation. By anchor item, it is generally meant that the item is the subject of the transaction data securely managed via the blockchain computational system.

It is assumed that such instruments, tools or equipment used in surgical operations may be represented by various properties or parameters, by way of example: a unique identifier (e.g. RFID, barcode, sensor, etc.), type, description (e.g., detailing how to use and handle during a procedure, how to serialize before or after use, etc.), list of authorized users of the instrument, etc.

Surgical instrument transactions may include, but not be limited to: registering an instrument, updating the status of the instrument, storing the usage information of the instrument, repairing information, test results of surgical instruments (e.g., material safety assessment, sterilization efficacy for reusable device, biocompatibility, heat test, etc.), etc.

All of the above data representing ID, location, use (as well as other data) with respect to a given surgical item is considered transaction data in accordance with illustrative embodiments. Such transaction data is what is provided to any given computing node 204-1, 204-2, 204-3, 204-4, . . . , 204-N (from data source 202 or some other computing node) for use in computing a blockchain, for example, as described above in the context of FIG. 1. The transaction data controller 210 is configured to receive or otherwise obtain the transaction data for each computing node, while the blockchain controller 212 is configured to compute the blockchain for each computing node. As will be further explained, the risk assessment controller 214 is configured to operate with the other controllers to track and assess risk with respect to the management of a given surgical tool. Such risk assessment can be used to trigger an addition to the blockchain, as well as to generate alerts or other actions.

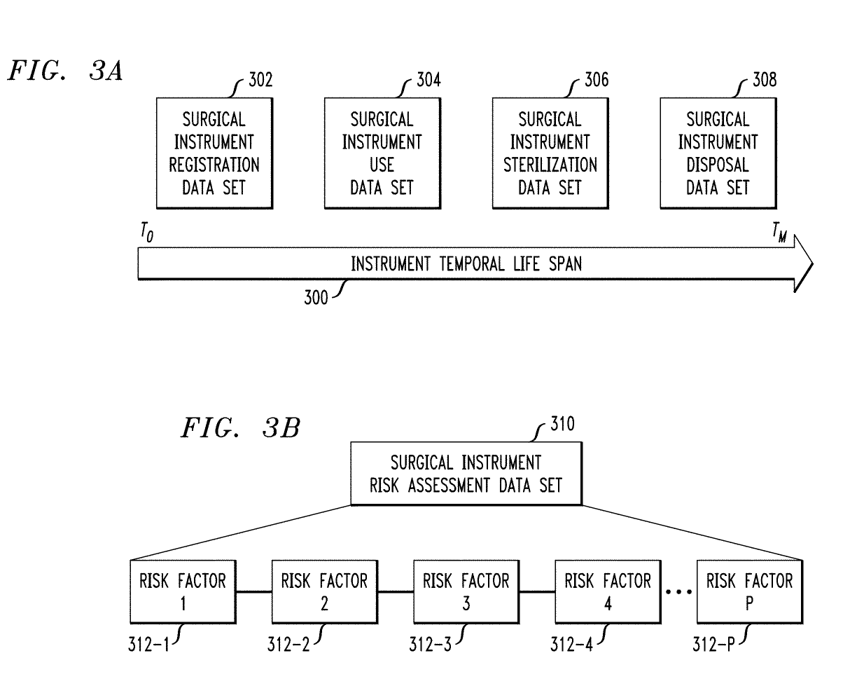

FIG. 3A illustrates a temporal life span 300 (T₀ through T_{M}) of a surgical item (surgical instrument, in this example) with the various transaction data sets 302 through 308 that may be tracked during that time period. Each of these data sets are added into the blockchain as they are obtained.

Instrument registration data set 302: Each instrument may be assigned a unique device identifier (UDI) and the registration of a surgical instrument is added to the blockchain ledger. Apart from recording the instrument UDI, if the instrument has been in use prior to the date of registration, its history of use is captured and added into the blockchain. Cameras, RFID scanners and other methods may be used to capture such identification data. These identification capture devices are considered part of the transaction data controller 210.

Instrument use data set 304: When an instrument is used in any operation location L, a transaction entry of use is added to the blockchain detailing the kind of procedure done, the user or doctor, patient disease(s), etc. Before an instrument is used in a procedure, risk assessment controller 214 queries the instrument history (e.g., from past transaction data in the blockchain) and assesses the likelihood of use in the current procedure and may also give recommendations (e.g., use the tool, do not use the tool, use the tool but with certain precautions, etc.). After use, a new block is added into the blockchain detailing the transaction. An operation location L may, for example, be one of: a surgical operation room, a home, an accident location, a battle field, etc.

Sterilization procedure data set 306: Some diseases (e.g., prion diseases which are a family of progressive neurodegenerative disorders that affect both humans and animals) constitute unique infection control problems. To prevent cross-transmission of infection from reusable medical instruments, after a procedure is carried out, the risk assessment controller 214 recommends the best sterilization procedure.

Instrument disposal data set 308: After exhaustive use of an instrument, it should be safely disposed. An instrument can be disposed after use in a procedure involving prion disease or other defined reasons. This device is marked in the blockchain as disposed and can no longer be used in any procedures. That is, once the item is marked disposed in the blockchain, if the same item is scanned for subsequent use, the risk assessment controller 214 generates an alert message to indicate to personnel that the item should not be used. Perhaps if it is an item that requires activation (automated calibration, start up, etc.) for use, the system can take automated steps to prevent its activation. Advantageously, the item's history is immutably recorded on the blockchain.

It is realized that a robust instrument tracking solution, in accordance with illustrative embodiments described herein, can help prevent hospital acquired infections by ensuring that each surgical instrument in use is sterilized using the requisite procedures and guidelines. Tracking and detecting the use of surgical instrument is accomplished via the computing platform 200 in FIG. 2 by analyzing the instrument history (e.g., sanitization or sterilization state, malfunctions and failures) and cohort by obtaining a historical block identifier of the instrument's historical blockchain, assessing the validity of the instrument is for indicated purposes (e.g., identifying or detecting inappropriate laser for tattoo removal), and matching the instrument and its intended usage (e.g., wrong application, improper use, or unapproved use of equipment). Methods and systems for tracking and detecting may comprise, in addition to other data capture devices mentioned above, use of a high definition camera system, visual analytics, and deep neural network to detect the use of surgical instruments or tools in an operation room.

Endoscopes may also be tracked. For example, in the past, the Center for Disease Control (CDC) confirmed superbug transmission via endoscope. Some hospitals subsequently switched from automated high-level disinfection to gas sterilization with ethylene for endoscope reprocessing. The computing platform 200 in FIG. 2 may be configured to track these types of sterilization procedures for endoscopes.

Dental tools may also be tracked, in accordance with illustrative embodiments, since it is realized that dental healthcare workers, through occupational exposure, may have a ten times greater risk of becoming a chronic hepatitis B carrier than the average person. As such, the computing platform 200 in FIG. 2 may be configured to track sterilization procedures for dental tools.

Again, any surgical instrument transactions associated with a stakeholder are compiled into a chain of surgical inventory transaction blocks. The chain is considered a chronicle of a surgical item's path through time, e.g., time during an operation, time through a day of operations, time through a month of operations, holiday days versus traditional days, time in transit to other wings of a hospital or entirely different facilities (if tools are moved to other facilities, etc.), battlefields, etc. When a transaction is conducted (e.g., a tool is used or accessed), the corresponding tool parameters are obtained and sent to one or more validation computing nodes in the system. The computing nodes establish a validity of the transaction and generate a new block. Once the new block has been calculated it can be appended to the stakeholder's inventory blockchain.

A system according to embodiments of the invention may also record on any open blockchain network to be used for business needs in healthcare centers, hospitals, clinics, etc., user, location, usage, and maintenance data of surgical instruments.

Furthermore, as mentioned above, a system according to embodiments of the invention may also track a possible risk assessment data set. In one embodiment, a risk assessment data set can be a multidimensional vector with several dimensions of risk. FIG. 3B illustrates a risk assessment data set 310 with multiple risk factors 312-1, 312-2, 312-3, 312-4, . . . , 312-P. Risk assessment controller 214 manages this data set. These risk factors or dimensions can be any risk that is identified for a given surgical tool. By way of example only, such factors can be that the surgical tool will be used in a procedure performed on someone with the following conditions: Ebola; Enterovirus D68; Flu; Hantavirus; Hepatitis B; HIV/AIDS; Measles; MRSA; Pertussis; Rabies; Sexually Transmitted Disease; Shigellosis; Tuberculosis; West Nile Virus; and Zika. Thus, the risk factors 312-1, 312-2, 312-3, 312-4, . . . , 312-P in the data set 310 can respectively represent a list of diseases sought to be tracked, wherein each factor is represented by a binary value I/O set according to known information (e.g., 1 for disease known to be present in patient; 0 for disease not known to be present in patient).

The risk value need not be a scalar quantity but may take into account various dimensions of risk and disease spread. For example, different sterilization methods may have various degrees of efficacy for decontamination. Also, it may be known, only based on probability, that a user has disease A, disease B, or disease C, partly based on patient cohort. Also, morbidity has been defined as any departure, subjective or objective, from a state of physiological or psychological well-being. In practice, morbidity encompasses disease, injury, and disability. Such assessment also can contribute to the multidimensional estimation of risk represented by the risk factors in data set 310.

It is also to be appreciated that prion diseases constitute a unique infection control problem because prions exhibit unusual resistance to conventional chemical and physical decontamination methods. Recommendations to prevent cross-transmission of infection from medical devices contaminated by Creutzfeldt-Jakob disease (CJD) have been based primarily on prion inactivation studies. On the basis of the scientific data, only critical (e.g., surgical instruments) and semi-critical devices contaminated with high-risk tissue (i.e., brain, spinal cord, and eye tissue) from high-risk patients (those with known or suspected infection with CJD) require special treatment. Such CJD contamination considerations may be represented in the risk factors 312-1, 312-2, 312-3, 312-4, . . . , 312-P of data set 310.

Still further, the system according to embodiments of the invention also tracks the method used in sterilization including, but not limited to: autoclave; chemical methods; ethylene oxide (ETO) sterilization; chlorine dioxide (CD) gas sterilization; hydrogen peroxide sterilization; vaporized hydrogen peroxide sterilization; hydrogen peroxide plasma sterilization; radiation methods; gamma ray sterilization; and electron beam sterilization.

The system according to embodiments of the invention also detects illegal or unauthorized use of surgical instruments based on chain code designed specifically for tracking and detection. Some of these uses may be unsafe. Chain code is the implementation of the business logic in a computer programming language. Thus, business logic comprises one or more rules describing how things should be done and all participants agree to the rules. By way of example only, a business rule may describe the legal or authorized uses of a given surgical instrument. Advantageously, in illustrative embodiments, each participating computing node in the blockchain network runs the same chain code, and thus adheres to the same business logic/rules.

Accordingly, it is to be understood that risk assessment as embodied by the risk factors 312-1, 312-2, 312-3, 312-4, . . . , 312-P of data set 310 are included as part of the transaction data that is represented by a blockchain computed according to embodiment of the invention. The risk assessment can be used to trigger an update to the blockchain and/or be used to provide an alert or initiate some action commensurate with the risk. Thus, advantageously, determining risk R to a patient is based on: i) the results of tracking and detection of surgical instruments; ii) detecting the patient context C (e.g., tattoo removal for a patient with a known latex allergy) and surgical operation to be performed using information from an electronic medical record of the patient (the electronic record may be stored and maintained in another patient record historic blockchain); and iii) analysis of the healthcare personnel cohort (e.g., training or experience with the instrument, experience level with the type of the operation, etc.). Various advance analytics may be employed by the risk assessment controller 214 such as, but not limited to, device recommendation algorithms, health analytics, surgical instrument advisory analytics, etc.

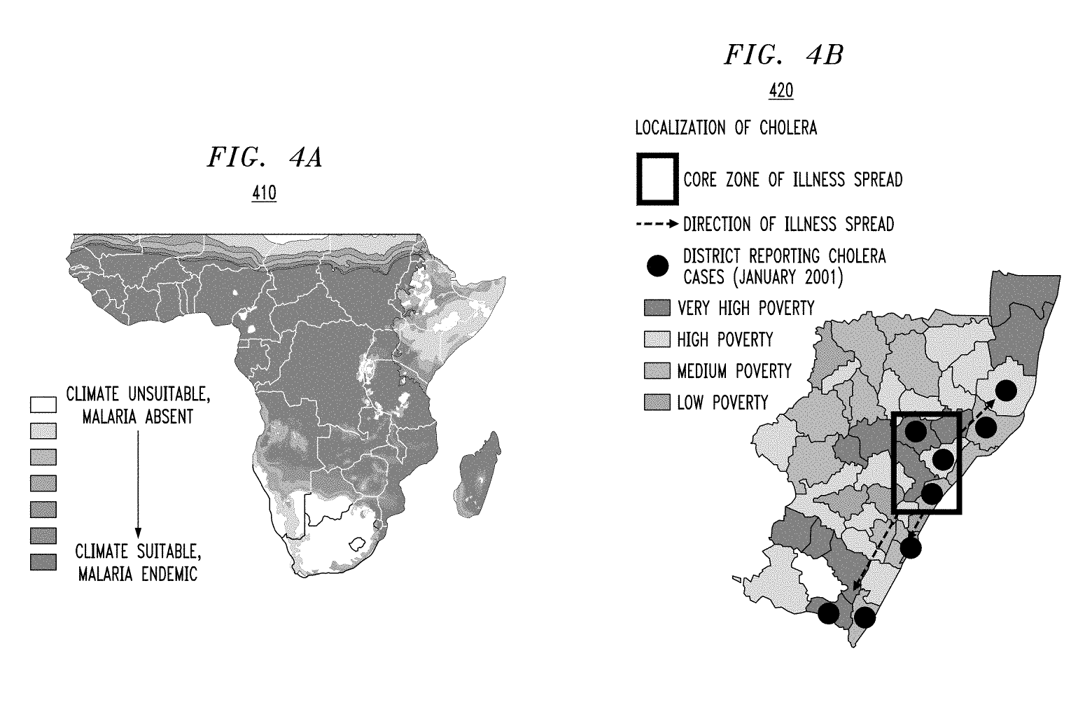

Maps of environmental information can also be used by the risk assessment controller 214 as early-warning tools for health planners and risk estimation for the blockchain system. For example, as depicted in map 410 in FIG. 4A, mapping environmental criteria in the determination of malaria prevalence may give insights into areas where malaria may be occurring. FIG. 4B illustrates a map 420 of the spread of a cholera outbreak as related to the degree of poverty in a given region. The data depicted in FIGS. 4A and 4B was published by the World Health Organization and the United Nations Environment Program through the Health and Environment Linkages Initiative. The information extracted from such maps serve as risk assessment-based transaction data that is tracked by the system and maintained as part of the blockchain. For example, based on the risk level, the system may send alerts or notify healthcare personnel (physicians and other healthcare professionals) to take the necessary action. The system may prevent the use of the instrument if the risk R is too high for the patient.

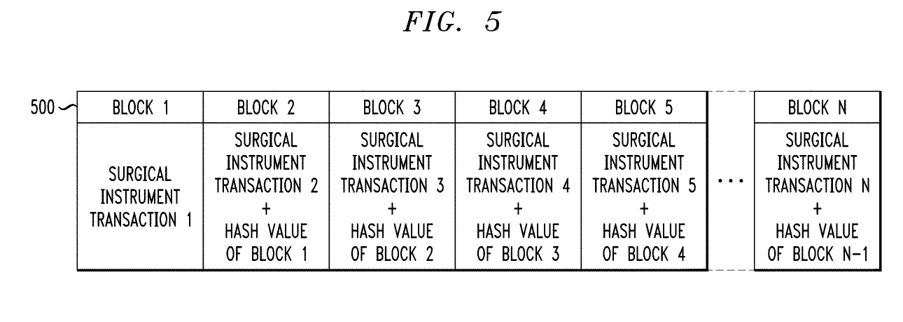

Given the above-described examples of transaction data (e.g., described in the context of FIGS. 3A, 3B, 4A and 4B), FIG. 5 illustrates a blockchain 500 for a surgical item according to an embodiment of the invention. Each computing node in the computing platform 200 is configured to compute blockchain 500. As shown, each block (after block 1) includes a new transaction for the surgical item plus a hash value computed for the previous block. Thus, each data block in the blockchain represents a given set of transaction data plus a set of all previous transaction data, e.g., block N contains data for surgical instrument transaction N plus a hash value that represents all previous N−1 blocks.

Note also that the unique identifier (UDI) or fingerprint token for a surgical instrument or tool may be used to form a decentralized instrument Internet of Things (IoT) network, wherein items are “smart devices” that are connected to the blockchain through their corresponding UDI or token. This may allow institutional wide tracking and detecting of surgical instruments, as well as for healthcare inventory management system. Such an IoT of instruments is embodied by the computing platform 200 in FIG. 2. That is, the instruments are trackable through the network(s) 205 that operatively couple the computing nodes that store the blockchain.

In another embodiment, on top of the blockchain, advanced analytics services may be provided (at one or more computing nodes in computing platform 200) to allow real-time tracking or detecting of equipment deficiencies during a procedure or during medication delivery. For example, breakage of surgical instruments (e.g., needles, scalpel blades), malfunctioning equipment or equipment failure (e.g., misfiring of a stapler; malfunction of a patient controlled analgesia pump), detachment of equipment (e.g., ureteric stone basket), defective equipment (e.g., rupture of a catheter balloon), lack of optimal equipment (e.g., lack of appropriate syringes), etc.

It is also to be appreciated that the system may protect the privacy and security of patients' record. This is achieved simply through the permissioned nature of the blockchain implementation, wherein only an authorized person has access to part or whole of the records. The system may facilitate authorization to access a patient record to medical personnel (e.g., a doctor, nurse, etc.) for limited duration through an authorization transaction that may be initiated by the patient himself. Such an authorization transaction may be initiated through any one of the computing nodes in computing platform 200. The use of the patient record without the patient authorization may be tracked and detected through a dedicated chain code. Such detection of unauthorized use may initiate amelioration actions (e.g., send a notification to the patient, to law enforcement personnel, etc.).

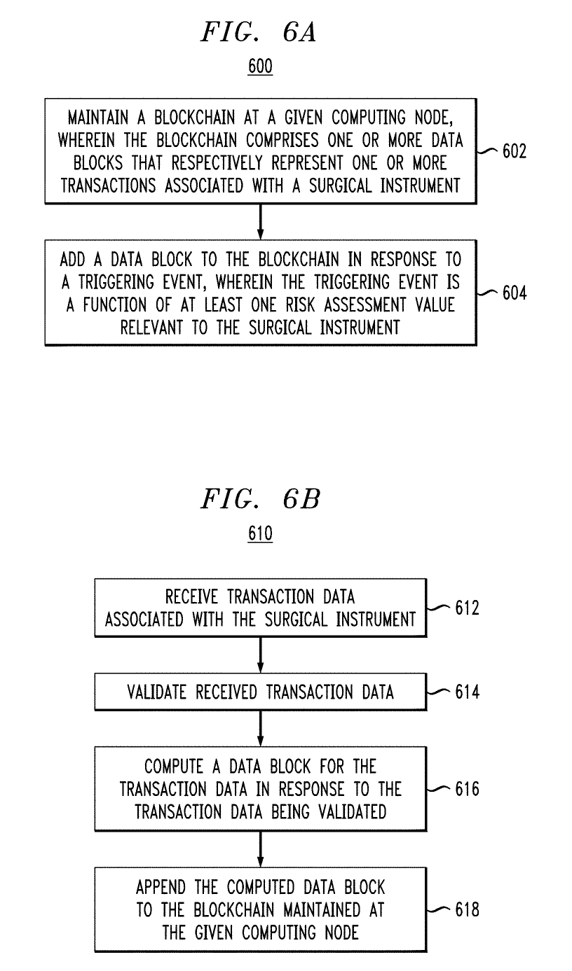

FIG. 6A illustrates a blockchain methodology 600 for tracking a surgical item according to an embodiment of the invention. This methodology 600 can be performed by each computing node in the computing platform 200. In step 602, a blockchain is maintained at a given computing node. The blockchain comprises one or more data blocks that respectively represent one or more transactions associated with a surgical instrument. Note that, in illustrative embodiments described herein, step 602 is performed by the blockchain controller 212 based on transaction data obtained through the transaction data controller 210. In step 604, a data block is added to the blockchain in response to a triggering event. The triggering event is a function of at least one risk assessment value relevant to the surgical instrument. Note that, in illustrative embodiments described herein, step 604 is performed by the blockchain controller 212 based on the risk assessment trigger managed by the risk assessment controller 214.

FIG. 6B illustrates a methodology 610 for adding data to a blockchain that is used to track a surgical item according to an embodiment of the invention. The methodology 610 is a more detailed example of step 604 in FIG. 6A. As shown, in step 612, a computing node in the computing platform 200 receives transaction data associated with the surgical instrument. In step 614, a computing node in the computing platform 200 validates the received transaction data. In step 616, a computing node in the computing platform 200 computes a data block for the transaction data in response to the transaction data being validated. In step 618, a computing node in the computing platform 200 appends the computed data block to the blockchain.

It is to be appreciated that each step of methodology 610 can be performed at the same computing node or the one or more steps can be separately performed at different computing nodes. That is, depending on the consensus protocol used (assuming one is used), the steps are distributively performed across the computing platform 200 or within each computing node. The result is that each computing node preferably maintains the same updated blockchain for the surgical instrument.

Among many advantages that are realized through the blockchain computational system described herein, some of the key advantages include: saving lives in places (such as Africa) where there is an acute medical personnel shortage; lock in attribution whereby the system can help create a permanent and unbreakable link between the user of a surgical item and the item and that link (record of ownership) can be forever verified and tracked; securely share one's digital content with colleagues such that transferring of work is made as easy as transferring or copying a surgical item; gaining visibility by tracing where and how a surgical item travels in a hospital, e.g., the system may show you the locations the item has appeared and its movement over time; and creating a certificate of authenticity (COA) whereby each registered item may come with a COA, a built in unique cryptographic ID and a complete ownership history (the COA can be verified anytime and printed out).

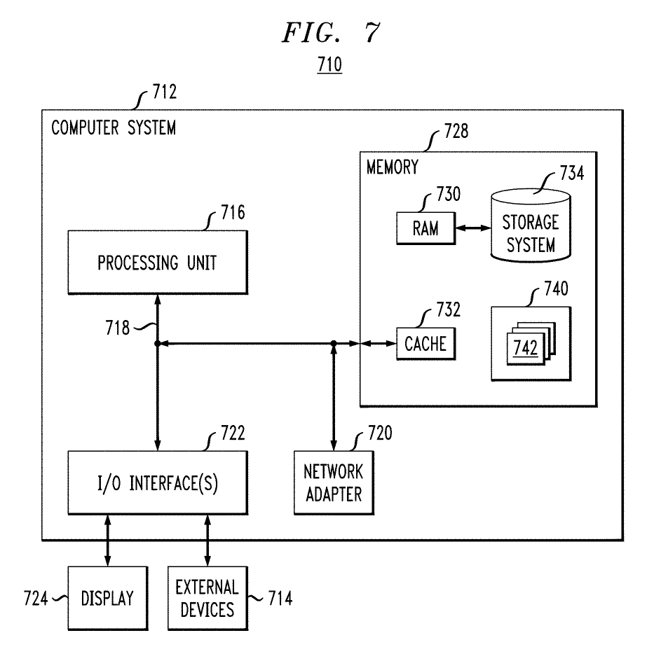

One or more embodiments can make use of software running on a computer or workstation. With reference to FIG. 7, in a computing node 710 there is a system/server 712, which is operational with numerous other general purpose or special purpose computing system environments or configurations. Examples of well-known computing systems, environments, and/or configurations that may be suitable for use with system/server 712 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each computing node in the computing platform 200 can implement the architecture shown in computing node 710.

System/server 712 may be described in the general context of computer system executable instructions, such as program modules, being executed by a computer system. Generally, program modules may include routines, programs, objects, components, logic, data structures, and so on that perform particular tasks or implement particular abstract data types. System/server 712 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, system/server 712 is shown in the form of a computing device. The components of system/server 712 may include, but are not limited to, one or more processors or processing units 716, system memory 728, and bus 718 that couples various system components including system memory 728 to processor 716.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

System/server 712 typically includes a variety of computer system readable media. Such media may be any available media that is accessible by system/server 712, and it includes both volatile and non-volatile media, removable and non-removable media.

The system memory 728 can include computer system readable media in the form of volatile memory, such as random access memory (RAM) 730 and/or cache memory 732. System/server 712 may further include other removable/non-removable, volatile/nonvolatile computer system storage media. By way of example only, storage system 734 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 718 by one or more data media interfaces.

As depicted and described herein, memory 728 may include at least one program product having a set (e.g., at least one) of program modules that are configured to carry out the functions of embodiments of the invention. A program/utility 740, having a set (at least one) of program modules 742, may be stored in memory 728 by way of example, and not limitation, as well as an operating system, one or more application programs, other program modules, and program data. Each of the operating system, one or more application programs, other program modules, and program data or some combination thereof, may include an implementation of a networking environment. Program modules 742 generally carry out the functions and/or methodologies of embodiments of the invention as described herein.

System/server 712 may also communicate with one or more external devices 714 such as a keyboard, a pointing device, an external data storage device (e.g., a USB drive), display 724, one or more devices that enable a user to interact with system/server 712, and/or any devices (e.g., network card, modem, etc.) that enable system/server 712 to communicate with one or more other computing devices. Such communication can occur via I/O interfaces 722. Still yet, system/server 712 can communicate with one or more networks such as a LAN, a general WAN, and/or a public network (e.g., the Internet) via network adapter 720. As depicted, network adapter 720 communicates with the other components of system/server 712 via bus 718. It should be understood that although not shown, other hardware and/or software components could be used in conjunction with system/server 712. Examples include, but are not limited to, microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

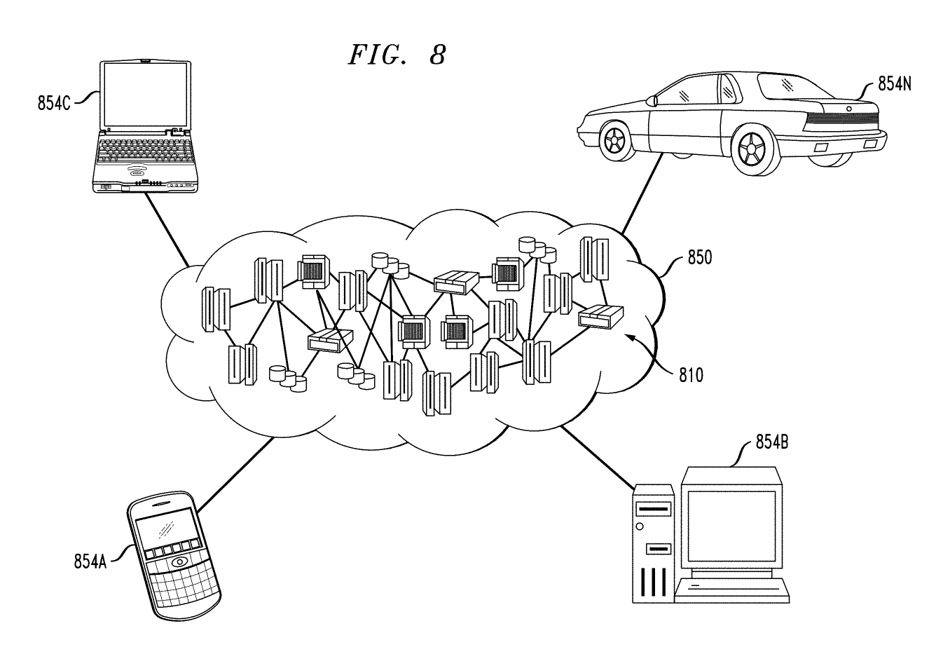

Referring now to FIG. 8, illustrative cloud computing environment 850 is depicted. As shown, cloud computing environment 850 includes one or more cloud computing nodes 810 with which local computing devices used by cloud consumers, such as, for example, personal digital assistant (PDA) or cellular telephone 854A, desktop computer 854B, laptop computer 854C, and/or automobile computer system 854N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 850 to offer infrastructure, platforms and/or software as services for which a cloud consumer does not need to maintain resources on a local computing device. It is understood that the types of computing devices 854A-N shown in FIG. 8 are intended to be illustrative only and that computing nodes 810 and cloud computing environment 850 can communicate with any type of computerized device over any type of network and/or network addressable connection (e.g., using a web browser).

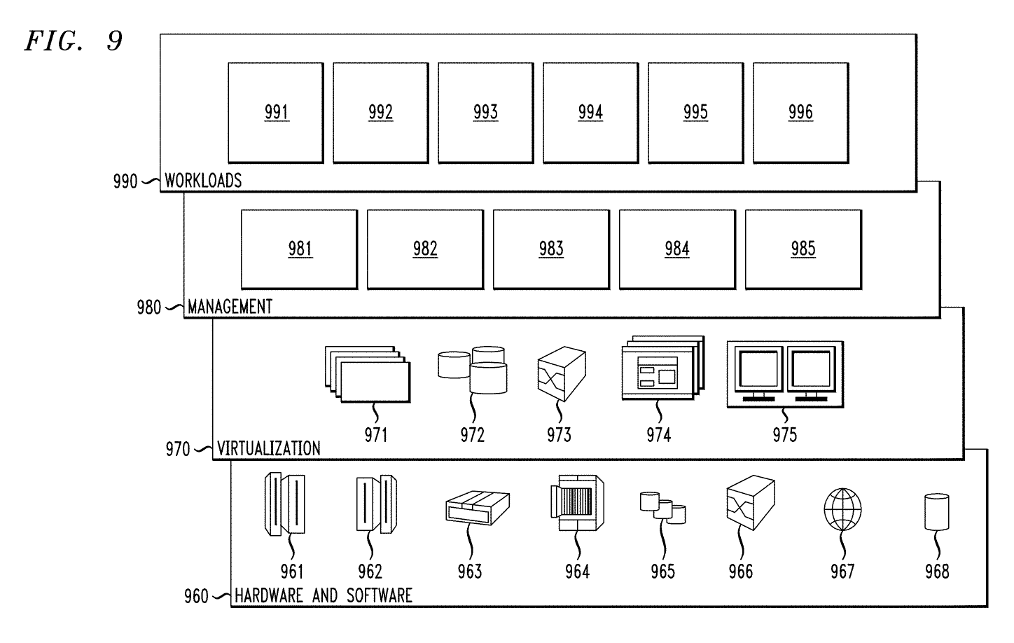

Referring now to FIG. 9, a set of functional abstraction layers provided by cloud computing environment 850 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 960 includes hardware and software components. Examples of hardware components include: mainframes 961; RISC (Reduced Instruction Set Computer) architecture based servers 962; servers 963; blade servers 964; storage devices 965; and networks and networking components 966. In some embodiments, software components include network application server software 967 and database software 968.

Virtualization layer 970 provides an abstraction layer from which the following examples of virtual entities may be provided: virtual servers 971; virtual storage 972; virtual networks 973, including virtual private networks; virtual applications and operating systems 974; and virtual clients 975.

In one example, management layer 980 may provide the functions described below. Resource provisioning 981 provides dynamic procurement of computing resources and other resources that are utilized to perform tasks within the cloud computing environment. Metering and Pricing 982 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 983 provides access to the cloud computing environment for consumers and system administrators. Service level management 984 provides cloud computing resource allocation and management such that required service levels are met. Service Level Agreement (SLA) planning and fulfillment 985 provide pre-arrangement for, and procurement of, cloud computing resources for which a future requirement is anticipated in accordance with an SLA.

Workloads layer 990 provides examples of functionality for which the cloud computing environment may be utilized. Examples of workloads and functions which may be provided from this layer include: transaction data capture 991; blockchain computation 992; data analytics processing 993; risk assessment 994; alert processing 995; and ameliorative/corrective/remedial action implementation 996, which may perform various functions described above.

Embodiments of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although illustrative embodiments have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method, comprising:
maintaining a secure chain of data blocks at a given computing node, wherein the given computing node is part of a set of computing nodes in a distributed network of computing nodes wherein each of the set of computing nodes maintains the secure chain of data blocks, wherein the secure chain of data blocks maintained at each computing node comprises one or more data blocks that respectively represent one or more transactions associated with a physical item used for providing a medical service; and
adding at least one data block to the secure chain of data blocks maintained at the given computing node in response to a triggering event associated with the physical item used for providing a medical service, wherein the triggering event is a function of at least one risk assessment value relevant to the physical item;
wherein the maintaining and adding steps are implemented via at least one processor operatively coupled to a memory associated with the given computing node.

2. The method of claim 1, wherein the physical item used for providing a medical service comprises a surgical instrument.

3. The method of claim 1, wherein the secure chain of data blocks represents a transaction path of the physical item through time.

4. The method of claim 1, wherein the adding step further comprises the given computing node:
receiving transaction data associated with the physical item used for providing a medical service;
validating the received transaction data;
computing a data block for the transaction data in response to the transaction data being validated; and
appending the computed data block to the secure chain of data blocks maintained at the given computing node.

5. The method of claim 4, wherein the transaction data is obtained by tracking the physical item.

6. The method of claim 5, wherein the transaction data for the physical item comprises one or more of: data representing identification of a user of the physical item; data representing identification of the physical item; data representing a location of the physical item; data representing usage of the physical item; data representing repair of the physical item; data representing cleaning of the physical item; and data representing testing of the physical item.

7. The method of claim 6, wherein the data representing usage of the physical item comprises data identifying that the physical item was used in a procedure that warrants sterilization of the physical item after the procedure.

8. The method of claim 6, wherein the data representing cleaning of the physical item comprises data specifying a sterilization procedure applied to the physical item.

9. The method of claim 4, wherein the transaction data for the physical item comprises a risk assessment data set.

10. The method of claim 9, wherein the risk assessment data set comprises multiple dimensions, wherein the multiple dimensions respectively represent multiple risk factors relevant to the physical item.

11. The method of claim 10, wherein the multiple risk factors comprise one or more of: a context of a patient with whom the physical item is to be used; a medical record of a patient with whom the physical item is to be used; healthcare personnel using the physical item; and a location at which the physical item is to be used.

12. The method of claim 9, wherein the risk assessment data set comprises alert data relevant to the physical device, and wherein the alert data is received from one or more medical information sources in geographic areas where the physical item will be used.

13. The method of claim 9, further comprising sending a message from the given computing node to initiate one or more actions with regard to the physical item based on the risk assessment data set.

14. The method of claim 1, wherein risk assessment value affects the frequency of occurrence of the triggering event such that the triggering event occurs more frequently when the risk assessment value indicates an increased risk associated with the physical item.

15. The method of claim 1, further comprising utilizing the secure chain of data blocks to manage the physical item.

16. The method of claim 15, wherein the utilizing step further comprises one or more of: accessing the secure chain of data blocks to determine a historical context associated with the physical item; and accessing the secure chain of data blocks to assess that the physical item is proper for its intended purpose.

17. The method of claim 1, wherein the secure chain of data blocks represents data relating to a given patient and is accessible by healthcare personnel for a limited duration of time based on an authorization initiated by the given patient.

18. The method of claim 17, wherein unauthorized access of the secure chain of data blocks representing data relating to the given patient is tracked and detected through a dedicated chain code, and triggers one or more ameliorative actions.

19. An apparatus, comprising:
at least one processor; and
a memory operatively coupled to the processor to form a given computing device that is part of a set of computing nodes in a distributed network of computing nodes wherein each of the set of computing nodes maintains a secure chain of data blocks, the processor and memory configured to:
maintain the secure chain of data blocks at the given computing node, wherein the secure chain of data blocks maintained at each computing node comprises one or more data blocks that respectively represent one or more transactions associated with a physical item used for providing a medical service; and
add at least one data block to the secure chain of data blocks maintained at the given computing node in response to a triggering event associated with the physical item used for providing a medical service, wherein the triggering event is a function of at least one risk assessment value relevant to the physical item.

20. A computer program product comprising a processor-readable storage medium having encoded therein executable code of one or more software programs, wherein the one or more software programs when executed by the one or more processors implement steps of:
maintaining a secure chain of data blocks at a given computing node, wherein the given computing node is part of a set of computing nodes in a distributed network of computing nodes wherein each of the set of computing nodes maintains the secure chain of data blocks, wherein the secure chain of data blocks maintained at each computing node comprises one or more data blocks that respectively represent one or more transactions associated with a physical item used for providing a medical service; and
adding at least one data block to the secure chain of data blocks maintained at the given computing node in response to a function of a triggering event associated with the physical item used for providing a medical service, wherein the triggering event is a function of at least one risk assessment value relevant to the physical item.
